(19) United States
(12) Patent Application Publication
(10) Pub. No.: US 2016/0110802 A1
(43) Pub. Date: Apr. 21, 2016

(54) Method for Brokering Lease Agreements Between Individual Lessors and Lessees

(71) Applicant: Johnny Moise, Brooklyn, NY (US)

(72) Inventor: Johnny Moise, Brooklyn, NY (US)

(21) Appl. No.: 14/884,410

(22) Filed: Oct. 15, 2015

Related U.S. Application Data
(60) Provisional application No. 62/064,022, filed on Oct. 15, 2014.

(51) Int. Cl. G06Q 30/06; G06Q 40/02

(52) U.S. Cl. CPC G06Q 30/0645; G06Q 40/025

(57) ABSTRACT

A system and method of connecting lessors and lessees. The present system and method connects lessors who have items available to be leased with lessees who are interesting in leasing those items. The system includes a database that contains a complete listing of users, where the listing includes user identification information, historical leasing data, items listed by users as available to be leased, and risk factors associated with the users. The risk factor is calculated by obtaining a credit worthiness score, such as a credit score from a credit bureau service, and combining that score with ratings obtained from lessors who engaged in prior transactions with that user. When a user identifies an item they wish to lease, they send a request over a network to the system. The requesting user's information is accesses and compared to the requirements for that item. If the requesting user's information falls within an acceptable range of risk, the transaction is approved and completed. Otherwise, the transaction is denied.

### CROSS REFERENCE TO RELATED APPLICATIONS

This application claims the benefit of U.S. Provisional Application No. 62/064,022 filed on Oct. 15, 2014. The above identified patent application is herein incorporated by reference in its entirety to provide continuity of disclosure.

### FIELD OF THE INVENTION

The present invention relates to a method of connecting lessors and lessees. More specifically, the present invention relates to a method for maintaining a database of lessors and lessees that contains risk factors associated with potential lessees and a method to determine whether to approve or reject a lease request based on such risk factors.

### BACKGROUND OF THE INVENTION

Over the last two decades the internet has significantly transformed the way in which individuals and companies conduct business. Every year a growing percentage of purchases occur online. There currently exist numerous virtual marketplaces that not only allow companies to sell their products over the internet, but also allow individuals to create listings to sell their own personal goods. One issue that users of such marketplaces encounter is that of trust; when dealing with an established retailer, most consumers are sufficiently satisfied with the reputation of the retailer that they are willing to patronize their business. But when consumers engage with non-professional sellers, it is often difficult to assess the reliability and honesty of the other party. In response to these concerns, many online marketplaces provide buyers a means of rating individual sellers. There ratings are incorporated into the online profile of the seller, and subsequent potential buyers can access and assess the seller's reputation and thus make a more informed purchasing decision.

While this buyer/seller rating model exists on popular selling platforms, there lacks a similar model in the area of rental agreements for privately owned goods. The trust issue that arises in the rental context differs in that the party requiring a higher level of trust is shifted from the party seeking the goods (buyer or lessee) to the one providing them (seller or lessor). The lessor is interested is being assured that a lessee will be able to make payments promptly and will treat the rental item appropriately. There is a need in the prior art for a rental model in which a rental transactional decision is made automatically based on feedback of a potential lessee that is calculated from prior transaction history as well as from credit worthiness.

### SUMMARY OF THE INVENTION

In view of the foregoing disadvantages inherent in the known types of online rental marketplaces now present in the prior art, the present invention provides a rental system and method wherein the same can be utilized for providing convenience for the user when seeking to engage in online rental activity. The present system comprises a database containing a listing of each user, where the listing includes user identification information, historical leasing data, items listed by the user as available to be leased, and a risk factor associated with the user. The risk factor is calculated by obtaining a credit worthiness score, such as a credit score from a credit bureau service, and combining that score with the ratings obtained from prior lessors who had engaged in prior transactions with that user.

When a user identifies an item they wish to lease, they send a request over a network to the system. The requesting user's information is accesses and compared to the requirements for that item. If the requesting user's risk factor falls within the acceptable range of risk for the item, the system approves the transaction. Otherwise, the transaction is denied.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of a database contained in the present invention.

FIG. 2 shows a diagram of the method of the present invention.

FIG. 3 shows a diagram of the present invention as connected through a telecommunication network.

### DETAILED DESCRIPTION OF THE INVENTION

Reference is made herein to the attached drawings. Like reference numerals are used throughout the drawings to depict like or similar elements of the system and method for connecting providers and requesters of available items. The figures are intended for representative purposes only and should not be considered to be limiting in any respect.

As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

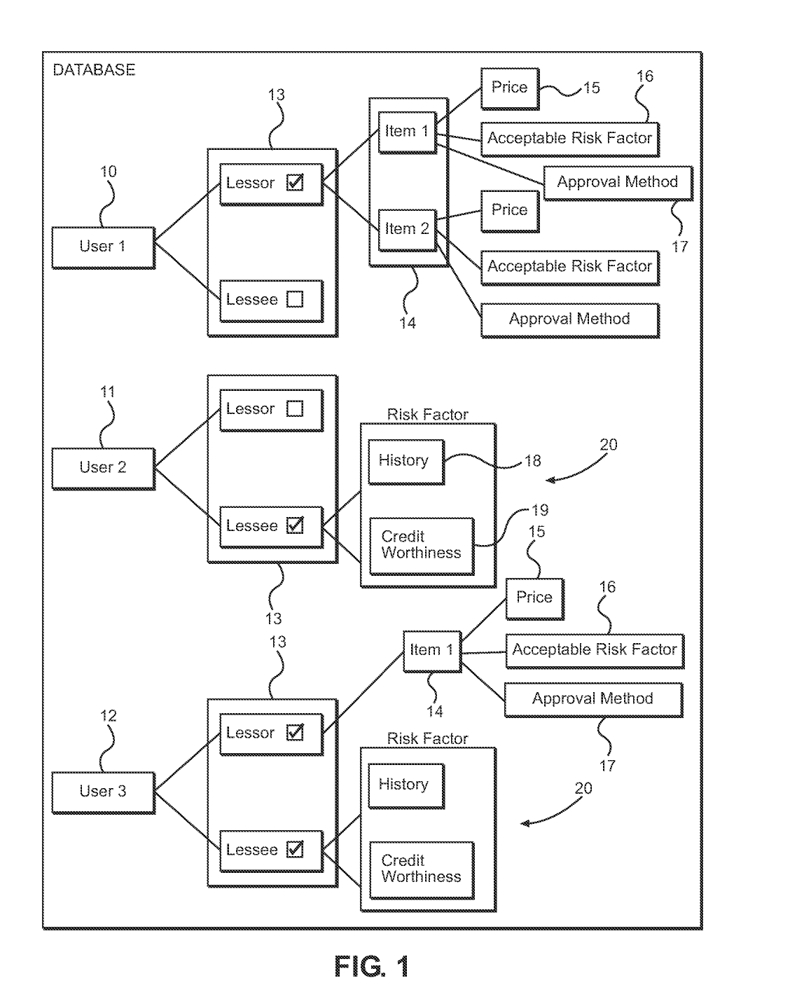

FIG. 1. is a diagram of the database used in the invention. The database contains a complete listing the users of the invention. Each user is assigned a profile made up of additional sublistings. The database containing the listing of the users and their associated profiles is stored on a computer-readable medium in a network connected device, such as a computer server that is comprised of a processor, the computer readable medium, memory and a network communication interface. Users are able to access and view the database through a network-accessible interface configured to connect to the computer server, such as on a web page or through a mobile application.

According to one embodiment of the invention, the transactions that occur over the system are leases. The invention consists of a database that contains three types of users. The first type of user 10 is labeled solely as a lessor 13. Such a user will have a profile that consists only of an inventory listing of items available to be leased 14. Each item has three additional sublistings: the price that the item is to be leased for 15, the acceptable range of risk that is required for a lessee to be able to lease the item 16, and the approval method of that item 17. All three of these sublistings are chosen by the user. The acceptable range of risk is a range of numbers that indicates what level of risk associated with a lessee is acceptable in order for that lessee to be able to lease the item. The approval method can either be automatic approval or pending approval.

A second type of user is labeled solely as a lessee 11. This user does not have an inventory listing. Instead, the user has a profile 19 that constitutes their risk factor. The risk factor is made up two subparts: the user's history of leases 17 from past transactions completed using the system, and their credit worthiness 18. The user's history of leases is a number rating that is based upon feedback from lessors who have conducted prior transactions with the user as well as the lessee's payment histories for those prior transactions, including records of whether each payment was made in full and if the payments were made in a timely manner. Credit worthiness of the lessee is established based on external considerations, such as a credit report generated from a credit bureau and financial standing established by copies of annual tax returns. This information is gathered and entered into the database when a user's account is created.

An additional embodiment of the database used in the invention can include other sublistings under the items that are available for lease, such as pictures and written descriptions of the items. The written descriptions can include relevant information such as the date of manufacture, the date of purchase, the price of the original purchase and the current condition of the item. There can also be a sublisting of the number of available items to be leased, if multiple items of the same sort are available from that lessor.

Another embodiment of the database has an expanded user profile for lessors. In addition to an inventory of items available to be leased 14, there are also records of past transactions and a numerical value associated with the lessor based on ratings given by lessees who engaged in previous transaction with that lessor. These records and ratings are made available for lessees to see while browsing available items from the database to provide a means of evaluating the reliability of a lessor.

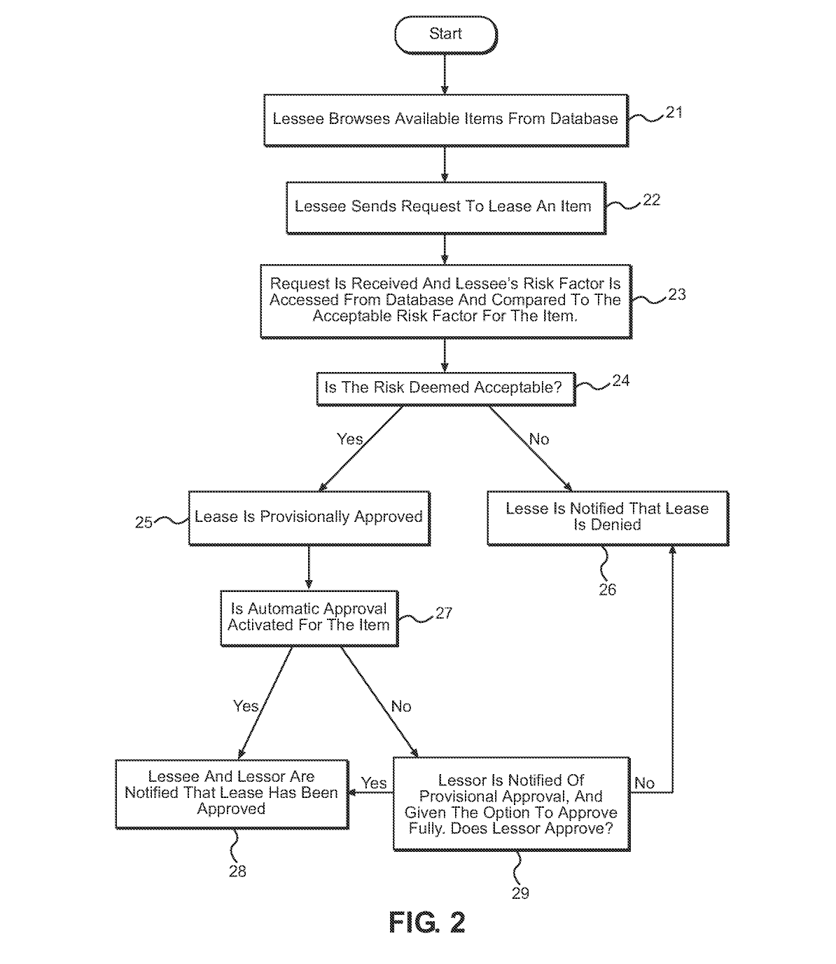

Referring now to FIG. 2, there is shown a diagram that illustrates the method of operation of the present invention. The user who wishes to lease an item begins by accessing the database through a network connected interface, such as a web site or a mobile application configured to access the database, and browsing the items which are currently available to be leased 21. Once the user has decided which item they wish to lease, they send a request 22 for that item over the network. The request is received by the system, and the requestor's profile is accessed and their risk factor 20 is retrieved from the database. The system then compares 23 the risk factor of the user 20 to the acceptable range of risk of that item 16. If the risk factor falls outside the acceptable range, the system disallows the lease and the lessee is notified that the request has been denied 26. If the risk factor falls within the acceptable range, the system provisionally approves the lease 25. The system's next step will depend on the approval method assigned to that item 17. If the approval method for the item is automatic approval, then the system automatically approves the lease, and the lessee and lessor are both notified of the successful transaction 27. If the approval method for the item is pending approval, the system does not allow the transaction to go through automatically. Rather, the system notifies the potential lessor that a lease request has been sent, and that the lessee possesses a risk factor that falls within the acceptable range of risk. The system provides the potential lessor with a choice to approve or deny the lease after reviewing the lessee's profile 29. This method provides the lessor with final approval power, even if the lessee's risk factor falls within the acceptable range. For example, it is possible that a lessee will have a risk factor within the acceptable range, but only have a very short history of prior leases. If a lessor feels uncomfortable about the potential transaction because of the limited history, denial of the transaction is still an option.

An additional embodiment of the invention is where the system assigns a dynamic price for the item such that the price can be raised or lowered according to the risk level of the requesting lessee. For example, the system may calculate that an item may cost $100 per month to lease for a lessee with a desirable risk factor, but will cost $200 per month for a lessee with an undesirable risk factor. The range of prices and acceptable risk factors can be decided by the lessor and entered into the database when the listing for the item is created or can be assigned and calculated automatically by the system.

A further embodiment of the invention is one wherein a successful lease can be transitioned into a sale. This is accomplished by having the system provide the lessee and the lessor with the option to transition the lease into a sale at any time during the lease period. The pricing and payment methods are to be decided by the lessor and the lessee.

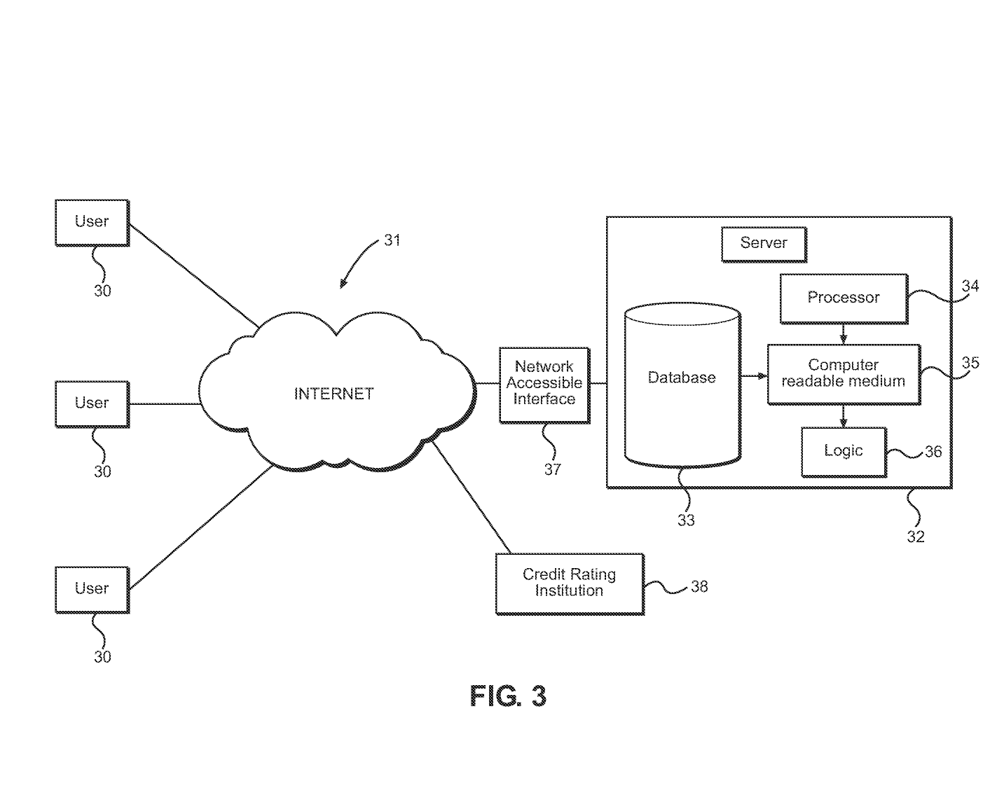

Referring now to FIG. 3, a diagram of the invention is shown as connected through a telecommunications network. The server 32 comprises the database 33, which is stored in a computer readable medium 35, a processer 34, and a logic 36 that contains the steps of the method of the invention. Individual users 30 can access the database through the internet 31 by means of a network-accessible interface 37, such as on a web page or through a mobile application, that is configured to connect to the server 32.

The credit worthiness rating of a user is created by gathering financial information, such a credit reports. There are accessed from a third party, such as a credit rating institution 38, through the internet 31. Additionally, financial information such as tax returns are submitted by the user 30 to the database 33 through the internet 31 when the user initially sets up their account.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A computer system comprising:
a processor;
a non-transitory computer readable medium operatively connected to the processor;
a logic stored in the non-transitory computer readable medium that, when executed by the processor, causes the computer system to perform a method, the method comprising the steps of:
maintaining a subscriber list, the subscriber list comprising a provider and a requester;
maintaining an available item for the provider, wherein an acceptable range of risk is associated with the available item;
maintaining a risk factor associated with the requester, wherein the risk factor is calculated as a function of a past leasing history and a credit worthiness rating;
receiving a request from the requester to lease an available item;
denying the request if the risk factor of the requester falls outside of the acceptable range of risk of the available item;
approving the request if the risk factor of the requester falls within the acceptable range of risk of the available item.

2) The computer system of claim 1, wherein if the request is approved, a purchase transaction is completed for the requested item.

3) The computer system of claim 1, wherein if the request is approved, the provider is given an option to complete a purchase transaction for the requested item.

4) The computer system of claim 1, wherein the request is a lease.

5) The computer system of claim 4, wherein one of the provider and requester can request the lease be converted to a sale.

6) The computer system of claim 1, wherein the request is a sale.

7) A non-transitory computer readable medium that, when executed by a processor of an computer system, causes the computer system to perform a method, the method comprising the steps of:
maintaining a subscriber list, the subscriber list comprising a provider and a requester;
maintaining an available item for the provider, wherein an acceptable range of risk is associated with the available item;
maintaining a risk factor associated with the requester, wherein the risk factor is calculated as a function of a past leasing history and a credit worthiness rating;
receiving a request from the requester to lease an available item;
denying the request if the risk factor of the requester falls outside of the acceptable range of risk of the available item;
approving the request if the risk factor of the requester falls within the acceptable range of risk of the available item.

8) The non-transitory computer readable medium of claim 7, wherein if the request is approved, a purchase transaction is completed for the requested item.

9) The non-transitory computer readable medium of claim 7, wherein if the request is approved, the provider is given an option to complete a purchase transaction for the requested item.

10) The non-transitory computer readable medium of claim 7, wherein the request is a lease.

11) The non-transitory computer readable medium of claim 10, wherein one of the provider and requester can request the lease be converted to a sale.

12) The non-transitory computer readable medium of claim 7, wherein the request is a sale.

13) A computer-implemented method comprising the steps of:
maintaining a subscriber list, the subscriber list comprising a provider and a requester;
maintaining an available item for the provider, wherein an acceptable range of risk is associated with the available item;
maintaining a risk factor associated with the requester, wherein the risk factor is calculated as a function of a past leasing history and a credit worthiness rating;
receiving a request from the requester to lease an available item;
denying the request if the risk factor of the requester falls outside of the acceptable range of risk of the available item;
approving the request if the risk factor of the requester falls within the acceptable range of risk of the available item.

14) The computer-implemented method of claim 13, wherein if the request is approved, a purchase transaction is completed for the requested item.

15) The computer-implemented method of claim 13, wherein if the request is approved, the provider is given an option to complete a purchase transaction for the requested item.

16) The computer-implemented method of claim 13, wherein the request is a lease.

17) The computer-implemented method of claim 16, wherein one of the provider and requester can request the lease be converted to a sale.

18) The computer-implemented method of claim 13, wherein the request is a sale.
